(19) United States
(12) Patent Application Publication
(10) Pub. No.: US 2017/0012900 A1
(43) Pub. Date: Jan. 12, 2017

(54) SYSTEMS, METHODS, AND APPARATUS FOR VERIFICATION OF A NETWORK PATH

(71) Applicant: Infinera Corporation, Annapolis Junction, MD (US)

(72) Inventors: Sri Mohana Satya Srinivas SINGAMSETTY, Sunnyvale, CA (US); Srini SEETHARAMAN, Sunnyvale, CA (US); Balaji BALASUBRAMANIAN, Sunnyvale, CA (US)

(21) Appl. No.: 14/794,409

(22) Filed: Jul. 8, 2015

(51) Int. Cl. H04L 12/937; H04L 12/751; H04L 12/26; H04L 12/24; H04L 12/46

(52) U.S. Cl. CPC H04L 49/254; H04L 41/12; H04L 12/4641; H04L 43/50; H04L 45/08

(57) ABSTRACT

An exemplary network controller may be configured to perform path verification using a special packet prepared by the controller. The controller initiates the special packet at the head end of the service. Thereafter, each physical node in the path will be programmed with special flow entries to take this data path verification packet to the controller at each hop. The controller makes a note of this packet and also the path it has taken to reach the node that sent the packet. Then the data path verification packet will be resent by the controller to the next physical node in the computed path.

### FIELD OF DISCLOSURE

This disclosure relates generally to telecommunications networks and more specifically, but not exclusively, to path verification in telecommunications networks.

### BACKGROUND

Modern communication and data networks comprise network nodes, such as routers, switches, bridges, and other devices that transport data through the network. Over the years, the telecommunication industry has made significant improvements to the network nodes to support an increasing number of protocols and specifications standardized by the Internet Engineering Task Force (IETF). Creating and coupling the complex network nodes to form networks that support and implement the various IETF standards (e.g. virtual private networks requirements) has inadvertently cause modern networks to become labyrinth-like and difficult to manage. As a result, vendors and third-party operators continually struggle to customize, optimize, and improve the performance of the interwoven web of network nodes.

For example, MPLS networks have evolved over the last 10-15 years to become critically important for ISPs. They provide two key services: traffic engineering in IP networks and L2 or L3 enterprise VPNs. However as carriers deploy MPLS networks, they find that (a) even though the MPLS data plane was meant to be simple, vendors end up supporting MPLS as an additional feature on complex, energy hogging, expensive core routers; and (b) the IP/MPLS control plane has become exceedingly complex with a wide variety of protocols tightly intertwined with the associated data-plane mechanisms.

In recent years, Software defined networking (SDN) is an emerging network technology that addresses customization and optimization concerns within convoluted networks. SDN simplifies modern networks by decoupling the data-forwarding capability (e.g. a data plane) from routing, resource, and other management functionality (e.g. a control plane) previously performed in the network nodes. Network nodes that support SDN (e.g., that are SDN compliant) may be configured to implement the data plane functions, while the control plane functions may be provided by a SDN controller. Open application programming interface (API) services, such as the OpenFlow protocol, may manage the interactions between the data plane and control plane and allow for the implementation of non-vendor specific combinations of networking nodes and SDN controllers within a network. As a result, SDN in conjunction with an Open API service may provide numerous benefits to modern networks that include increased network virtualization, flexible control and utilization of the network, and customization of networks for scenarios with specific requirements.

A new approach to MPLS that uses the standard MPLS data-plane based on OpenFlow and with a simpler and extensible control-plane based on SDN Protocols. There are significant advantages in using this approach. The control-plane is greatly simplified and is de-coupled from a simple data-plane. And we can still provide all the services that MPLS networks provide today. More importantly we can do much more: we can globally optimize the services; make them more dynamic; or create new services by simply programming networking applications on top of the SDN Controller. However, problems still exist when using SDN with other protocols, such as a MPLS core, particularly with Operations, Administration, and Maintenance (OAM) functions.

For instance, OAM plays a critical role in SDN due to the nature of control plane and data plane separation in SDN. OAM is required in SDN to synchronize the data plane with the control plane and make them consistent. Any inconsistency can cause a black hole for the traffic and can be a very difficult problem to debug. When services are created with the SDN controller, then controller needs to make sure that the network path computed by the controller and the actual path programmed in the data path should be same. The controller also needs to periodically verify this consistency of the network path. Thus, a new path verification process is needed.

Accordingly, there is a need for systems, apparatus, and methods that improve upon conventional approaches including the improved methods, system and apparatus provided hereby.

### SUMMARY

The following presents a simplified summary relating to one or more aspects and/or examples associated with the apparatus and methods disclosed herein. As such, the following summary should not be considered an extensive overview relating to all contemplated aspects and/or examples, nor should the following summary be regarded to identify key or critical elements relating to all contemplated aspects and/or examples or to delineate the scope associated with any particular aspect and/or example. Accordingly, the following summary has the sole purpose to present certain concepts relating to one or more aspects and/or examples relating to the apparatus and methods disclosed herein in a simplified form to precede the detailed description presented below.

In one aspect, a method for verifying a data path from a first client device through a software defined network to a second client device may include: receiving a data path verification request from a first core node for the data path between the first client device and the second client device; sending, by the first core node, a notification of the data path verification request to a controller; sending, by the controller, a first data path verification packet to the first core node; receiving, by the first core node, the first data path verification packet; and sending, by the first core node, a second data path verification packet to a second core node, the second data path verification packet having information about the first data path verification packet.

In another aspect, a network element includes at least one transceiver configured to: send a notification of the data path verification request to a controller; receive a first data path verification packet from the controller; and send a second data path verification packet to the controller, the second data path verification packet having information about the first data path verification packet.

In still another aspect, a controller includes at least one transceiver configured to: receive a notification of a data path verification request from a first core node for a data flow path between a first client device and a second client device; send a first data path verification packet to the first core node; and receive a second data path verification packet from the first core node that includes information about the first data path verification packet.

Other features and advantages associated with the apparatus and methods disclosed herein will be apparent to those skilled in the art based on the accompanying drawings and detailed description.

### BRIEF DESCRIPTION OF THE DRAWINGS

A more complete appreciation of aspects of the disclosure and many of the attendant advantages thereof will be readily obtained as the same becomes better understood by reference to the following detailed description when considered in connection with the accompanying drawings which are presented solely for illustration and not limitation of the disclosure, and in which:

FIG. 1 illustrates an exemplary network diagram in accordance with some examples of the disclosure.

FIG. 2 illustrates another exemplary network diagram with virtual and physical components in accordance with some examples of the disclosure.

FIG. 3A illustrates example components of a network device in accordance with some examples of the disclosure.

FIG. 3B illustrates example components of a device in accordance with some examples of the disclosure.

FIG. 4 is a diagram of an exemplary a network node device in accordance with some examples of the disclosure.

FIG. 5 is a diagram of an exemplary computer system device in accordance with some examples of the disclosure.

In accordance with common practice, the features depicted by the drawings may not be drawn to scale. Accordingly, the dimensions of the depicted features may be arbitrarily expanded or reduced for clarity. In accordance with common practice, some of the drawings are simplified for clarity. Thus, the drawings may not depict all components of a particular apparatus or method. Further, like reference numerals denote like features throughout the specification and figures.

### DETAILED DESCRIPTION

The exemplary methods, apparatus, and systems disclosed herein advantageously address the industry needs, as well as other previously unidentified needs, and mitigate shortcomings of the conventional methods, apparatus, and systems. For example, a controller may be configured to provide path verification by using a special OAM packet (data path verification packet) prepared by the controller. The controller initiates the OAM packet at the head end of the service. Thereafter, each physical node in the path will be programmed with special flow entries to take this OAM packet to the controller at each hop. The controller makes a note of this packet and also the path it has taken to reach the node that sent the packet. Then the OAM packet will be resent by the controller to the next physical node in the computed path.

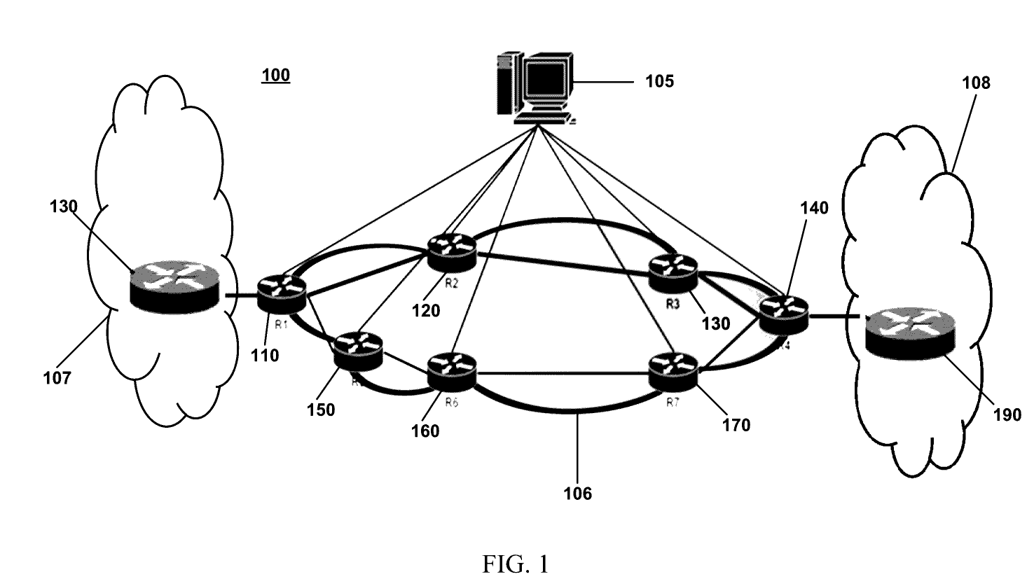

FIG. 1 illustrates an exemplary network diagram in accordance with some examples of the disclosure. As shown in FIG. 1, a telecommunications network 100 may include a controller 105, a core network 106, a first client network 107, and a second client network 108. The telecommunications network 100 may include the controller 105 communicatively coupled to a first core node 110 (R1), a second core node 120 (R2), a third core node 130 (R3), a fourth core node 140 (R4), a fifth core node 150 (R5), a sixth core node 160 (R6), and a seventh core node 170 (R7). The plurality of core nodes 110-170 may be network devices, such as flow programmable switches, routers, or similar devices. The controller 105 may be communicatively coupled to each of the plurality of nodes 110-170 and each of the plurality of nodes 110-170 may be selectively coupled directly with each other to form various data paths through the telecommunications network 100. While only seven nodes are shown, it should be understood that the telecommunication network 100 may include many more nodes (many hundreds of nodes for example). The first client network 107 may include a first client node 180 (or first client device) communicatively coupled to the core network 106, such as through a connection to the first core node 110. The second client network 108 may include a second client node 190 (or second client device) communicatively coupled to the core network 106, such as through a connection to the second core node 120. While the first client network 107 and the second client network 108 is shown with one node, it should be understood that more nodes (or less) may be present in each network.

Each of the plurality of core nodes 110-170 may be configured to implement data plane functions, such as the data-forwarding capability, while the controller 105 may be configured to implement the control plane functions, such as routing, resource, and other management functionality. In addition, functions previously performed by the core nodes 110-170 may be performed by the controller 105. For example, the controller 105 may be configured to provide a special OAM packet as part of a service mediator function with appropriate OAM parameters. For example, when the first client node 180 (source node) sends a data flow path request for a path through the core network 106 to the second client node 190 (destination node). This data flow path request enters the core network 106 at, for example, the first core node 110. The first core node 110 sends the data flow path request to the controller 105 for processing and path computation. While only one controller 105 is shown, it should be understood that more than one controller may be included and these multiple controllers may be co-located or located is separate geographic locations. These multiple controllers may communicate with each other and, for example, the may co-manage the network resources, such as one controller may manage the network node close to the source client node and a different controller may manage the network node close to the target client node. In addition, the communication between a node, such as the first core node 110, and the controller 105 may use packet_out and packet_in messages. For example, when the first core node 110 sends a message to the controller 105, the message is sent as a packet_in message.

When the controller 105 receives the initial path request, the controller 105 will determine a route through the core network 106. For example, the controller 105 may determine the optimal path through the core network 106 is from the first core node 110 to the core second node 120 then to the third core node 130 followed by the fourth core node 140 and onward to the second client node 190 (destination node). The controller 105 may use a service mediator module with an OAM engine to send the computed path to each of the core nodes 110-140 along the computed path and start the process of verifying the path taken. The service mediator module and OAM engine may be located in each core nodes 110-140 along the computed path and, alternatively in the controller 105 as well or just the controller 105. These core nodes 110-140 will store the computed path information, such as the next core node in the computed path. The controller 105 may send each of the core nodes 110-140 the entire path information or just the next node the receiving node will use to transfer incoming packets. For the verification process, the controller 105 may initiate an OAM packet with instructions to append path information to the OAM packet and then send the appended OAM packet back to the controller 105 as verification of the computed path. Thus, each physical core node 110-140 in the computed path may be programmed with special flow entries to send the appended OAM packet to controller 105 at each hop. The controller 105 may include the OAM engine as part of the service mediator module to make a note of each appended OAM packet received by the controller 105 along with the path information related to the path the appended OAM packet has travelled through the core network 106 so far. Then, the appended OAM packet may be resent by the controller 105 to the next physical core node in the computed path for verification.

In an alternative configuration, the controller 105 may initiate an OAM packet with instructions to append path information to the OAM packet and then send the appended OAM packet back to the controller 105 as well as the next core node in the computed path as verification of the computed path. Thus, each physical core node 110-140 in the computed path may be programmed with special flow entries to take the appended OAM packet to controller 105 at each hop as well as forwarding the appended OAM packet to the next core node in the computed path.

In either configuration, the appended OAM packet is sent to the controller 105 at each hop of the computed path. The controller 105 may perform verification of the computed path versus the actual path information appended to the OAM packet based on different parameters of the OAM packet. The controller 105 can then verify that the path recorded by the controller 105 and the actual physical path taken by the OAM packet are the same. Once the end-to-end path is verified, the OAM engine in the service mediator of the end core node 140 may reply back with a verification OAM packet to indicate that the computed path in the controller 105 and the actual physical path taken by the appended OAM packet are consistent with each other. In case there is any inconsistency, the OAM engine of the node that finds the inconsistency will reply back to the controller 105 with the appropriate OAM packet to indicate that the paths in the controller 105 and the actual physical path for the OAM packet has travelled are inconsistent. This may allow the controller 105 to amend the computed path information or computed a new path and restart the verification process with a new OAM packet.

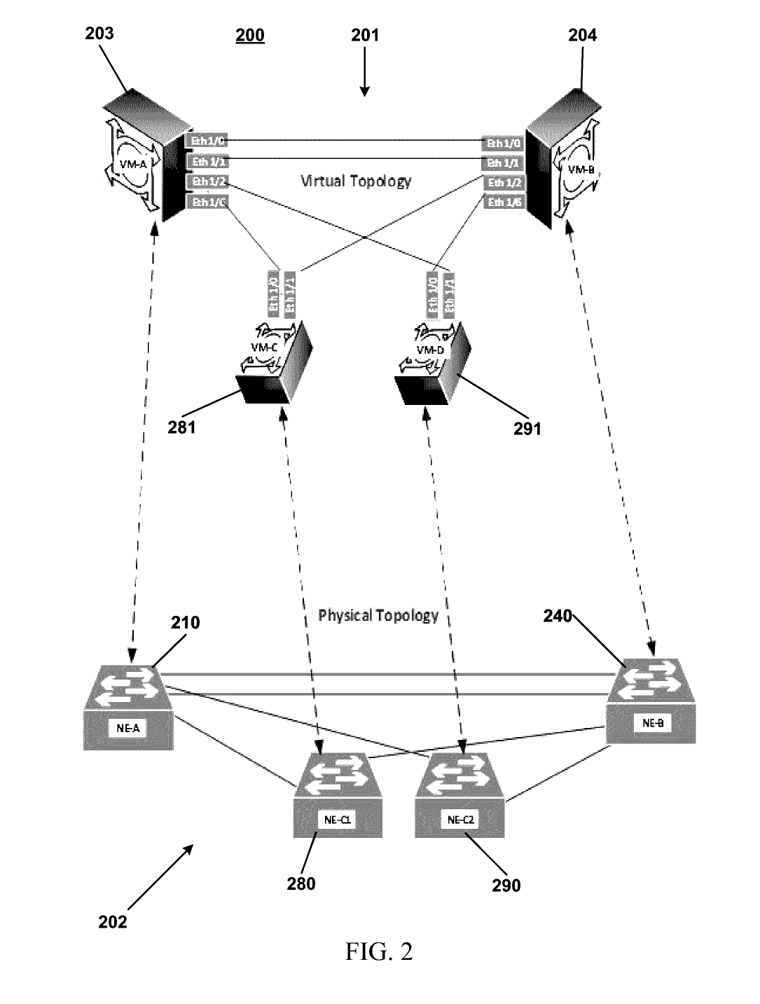

FIG. 2 illustrates another exemplary network diagram with virtual and physical components in accordance with some examples of the disclosure. With the separation of the control plane functions in a centralized controller, such as controller 105, the virtual network topology may differ from the physical topology such that L2 and L3 services may be separated due to the software functionality like the control plane differing from the physical switch or router functions in the core nodes, such as core nodes 110-140. For example, if one of the core nodes loses connectivity with the centralized controller, it is difficult to verify that the physical path packets are traveling is the same as the path computed by the controller and programmed into the core nodes along the computed path. As shown in FIG. 2, a telecommunication network 200 may be configured to include a virtual topology 201 composed of the virtual connections and a physical topology 202 composed of the physical connections. The virtual topology 201 may be viewed as including a first controller 203 with interfaces eth1/0, eth1/1, eth1/2, and eth 1/6; a second controller 204 with interfaces eth1/0, eth1/1, eth1/2, and eth 1/6; a first client network element 281 with interfaces eth1/0 and eth1/1; and a second client network element 291 with interfaces eth1/0 and eth1/1. While the virtual topology 201 shows the first controller 203 and the second controller 204 as separate devices, it should be understood that the first controller 203 and the second controller 204 may be the same device (such as controller 105). The physical topology 202 may be viewed as including a first core network element 210 (such as the first core node 110) and a second core network element 240 (such as the fourth core node 140) communicatively coupled together to form a path through a core network (such as the core network 106) along with a first client network element 280 (such as the first client node 180) and a second client network element 290 (such as the second client node 190) communicatively coupled to respective ones of the first core network element 210 and the second core network element 240.

With reference to FIG. 2, an example path verification process may include establishing a path between the first client network element 280 and the second client network element 290. For instance, the first client network element 280 may send a path request to the first core network element 210 for establishing a data path or flow between the first client network element 280 and the second client network element 290. The first core network element 210 may send a path request to the first controller 203. The first controller 203 may compute a network path for the data flow from the first core network element 210 to the second core network element 240 and then onto the second client network element 290. The first controller 203 may establish a virtual path from the eth1/0 interface (such as an ingress interface) of the first client network element 281 to the eth1/6 interface the first controller 203, from the eth1/1 (such as an egress interface) of the first client network element 281 to the eth1/2 interface of the second controller 204, from the eth1/0 interface (such as an egress interface) of the second client network element 291 to the eth1/6 interface the second controller 204, from the eth1/1 (such as an ingress interface) of the second client network element 291 to the eth1/2 interface of the first controller 203. The first controller 203, in conjunction with the second controller 204, may initiate a path verification process with an OAM packet as described above with reference to FIG. 1. The OAM packet may include information of the physical interfaces traversed by the OAM packet. This will allow the controllers 203 and 204 to verify the physical path conforms to the computed path. If, for example, the second core network element 240 does not send an appended OAM packet or sends the appended OAM packet with different interface information than that computed, the controllers 203 and 204 may adjust the computed path to conform to the physical path and interfaces or re-compute a new path for the data flow. Once the OAM packet reaches the final core network element in the computed path, the verification process may pause for a unicast data flow or may be resent in reverse order to verify a return path for a bi-directional data flow.

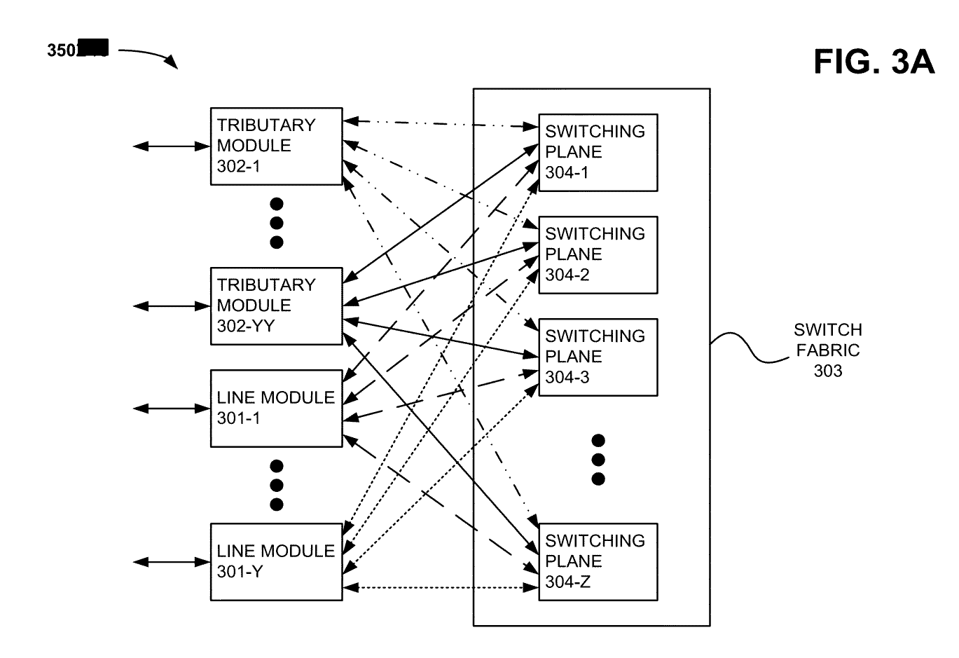

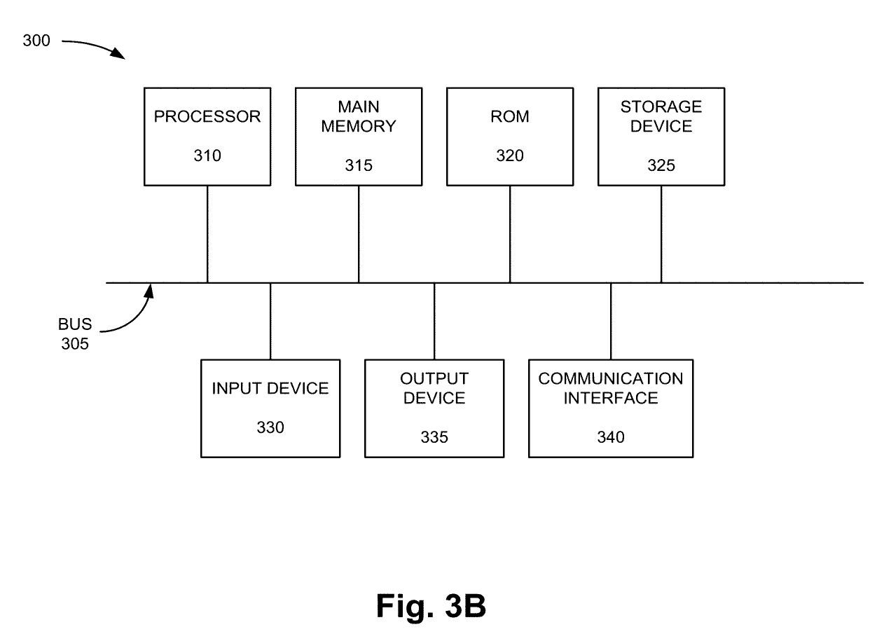

FIG. 3A is a diagram of example components of a network element 350 (for example, any of core nodes 110-170 or either of first client network element 280 and the second client network element 290). As shown in FIG. 3A, the network node 350 may include line modules 301-1, . . . , 301-Y (referred to collectively as “line modules 301,” and generally as “line module 301”) (where Y.gtoreq.1) and tributary modules 302-1, . . . , 302-YY (referred to collectively as “tributary modules 302,” and generally as “tributary module 302”) (where YY.gtoreq.1) connected to a switch fabric 303. As shown in FIG. 3A, switch fabric 303 may include switching planes 304-1, 304-2, . . . 304-Z (referred to collectively as “switching planes 304,” and generally as “switching plane 304”) (where Z.gtoreq.1).

Line module 301 may include hardware components, or a combination of hardware and software components, that may provide network interface operations. Line module 301 may receive a multi-wavelength optical signal and/or transmit a multi-wavelength optical signal (or similar signals such as Ethernet traffic). A multi-wavelength optical signal may include a number of optical signals of different optical wavelengths. In some implementations, line module 301 may perform retiming, reshaping, regeneration, time division multiplexing, and/or recoding services for each optical wavelength. Line module 301, associated with an ingress node, may also multiplex multiple signals into a super signal for transmission to one or more other core nodes.

Tributary module 302 may include hardware components, or a combination of hardware and software components, that may support flexible adding-dropping of multiple services, such as SONET/SDH services, gigabit Ethernet (Gbe) services, optical transport network (OTN) services, and/or fiber channel (FC) services. For example, tributary module 302 may include an optical interface device, such as a fiber optics module, a small-form pluggable (SFP) module, a tributary interface module (TIM), and/or some other type of optical interface device.

Switch fabric 303 may include hardware components, or a combination of hardware and software components, that may provide switching functions to transfer data between line modules 301 and/or tributary modules 302. In some implementations, switch fabric 303 may provide fully non-blocking transfer of data. Each switching plane 304 may be programmed to transfer data from a particular input to a particular output.

As shown in FIG. 3A, each of line modules 301 and tributary modules 302 may connect to each of switching planes 304. The connections between line modules 301/tributary modules 302 and switching planes 304 may be bidirectional. While a single connection is shown between a particular line module 301/tributary module 302 and a particular switching plane 304, the connection may include a pair of unidirectional connections (i.e., one in each direction).

While FIG. 3A shows a particular quantity and arrangement of components, network node 350 may include additional components, fewer components, different components, or differently arranged components than those illustrated in FIG. 3A. Also, it may be possible for one of the components of network node 350 to perform a function that is described as being performed by another one of the components.

FIG. 3B illustrates example components of a device 300 that may be used within the telecommunications network 100 of FIG. 1. Device 300 may correspond to a client device (such as the first client node 130, the second client node 140, the third client node 150, the first client network element 280, the second client network element 290, the first client network element 281, the second client network element 291 or the controller 105). Each device 300 may include one or more devices 300 and/or one or more components of device 300.

As shown in FIG. 3B, device 300 may include a bus 305, a processor 310, a main memory 315, a read only memory (ROM) 320, a storage device 325, an input device 330, an output device 335, and a communication interface 340.

Bus 305 may include a path that permits communication among the components of device 300. Processor 310 may include a processor, a microprocessor, an application specific integrated circuit (ASIC), a field programmable gate array (FPGA), or another type of processor that interprets and executes instructions. Main memory 315 may include a random access memory (RAM) or another type of dynamic storage device that stores information or instructions for execution by processor 310. ROM 320 may include a ROM device or another type of static storage device that stores static information or instructions for use by processor 310. Storage device 325 may include a magnetic storage medium, such as a hard disk drive, or a removable memory, such as a flash memory.

Input device 330 may include a component that permits an operator to input information to device 300, such as a control button, a keyboard, a keypad, or another type of input device. Output device 335 may include a component that outputs information to the operator, such as a light emitting diode (LED), a display, or another type of output device. Communication interface 340 may include any transceiver-like mechanism that enables device 300 to communicate with other devices or networks. In some implementations, communication interface 340 may include a wireless interface, a wired interface, or a combination of a wireless interface and a wired interface.

Device 300 may perform certain operations, as described in detail below. Device 300 may perform these operations in response to processor 310 executing software instructions contained in a computer-readable medium, such as main memory 315. A computer-readable medium may be defined as a non-transitory memory device. A memory device may include memory space within a single physical storage device or memory space spread across multiple physical storage devices.

The software instructions may be read into main memory 315 from another computer-readable medium, such as storage device 325, or from another device via communication interface 340. The software instructions contained in main memory 315 may direct processor 310 to perform processes described above. Alternatively, hardwired circuitry may be used in place of or in combination with software instructions to implement processes described herein. Thus, implementations described herein are not limited to any specific combination of hardware circuitry and software. In some implementations, device 300 may include additional components, fewer components, different components, or differently arranged components.

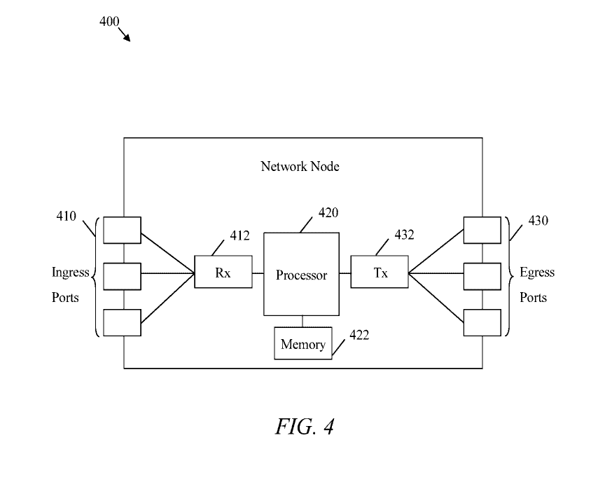

FIG. 4 illustrates an embodiment of a network element or node 400, which may be any device configured to transport data through a network. For instance, the network node 400 may correspond to the core nodes 110-170 or any other node. The network node 400 may comprise one or more ingress ports 410 coupled to a receiver 412 (Rx), which may be configured for receiving packets or frames, objects, options, and/or type length values (TLVs) from other network components. The network node 400 may comprise a logic unit or processor 420 coupled to the receiver 412 and configured to process the packets or otherwise determine which network components to send the packets. The processor 420 may be implemented using hardware, or a combination of hardware and software.

The network node 400 may further comprise a memory 422, which may be a memory configured to store a flow table, or a cache memory configured to store a cached flow table. The network node 400 may also comprise one or more egress ports 430 coupled to a transmitter 432 (Tx), which may be configured for transmitting packets or frames, objects, options, and/or TLVs to other network components. Note that, in practice, there may be bidirectional traffic processed by the network node 400, thus some ports may both receive and transmit packets. In this sense, the ingress ports 410 and the egress ports 430 may be co-located or may be considered different functionalities of the same ports that are coupled to transceivers (Rx/Tx). The processor 420, the memory 422, the receiver 412, and the transmitter 432 may also be configured to implement or support any of the schemes and methods described above, such as the process 200.

It is understood that by programming and/or loading executable instructions onto the network node 400, at least one of the processor 420 and the memory 422 are changed, transforming the network node 400 in part into a particular machine or apparatus (e.g. a SDN switch having the functionality taught by the present disclosure). The executable instructions may be stored on the memory 422 and loaded into the processor 420 for execution. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner, as a machine controlled by a new ASIC is a particular machine or apparatus, likewise a computer that has been programmed and/or loaded with executable instructions may be viewed as a particular machine or apparatus.

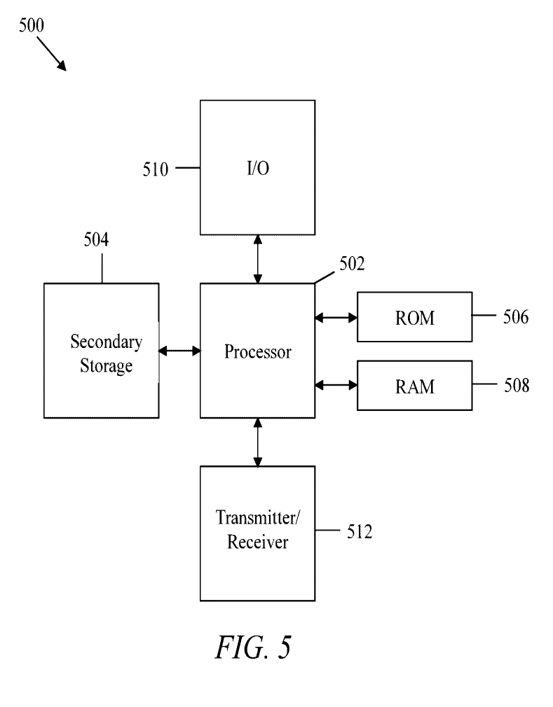

The system and schemes described above may be implemented on a network component or computer system, such as a computer or network component with sufficient processing power, memory resources, and network throughput capability to handle the necessary workload placed upon it. FIG. 5 illustrates an embodiment of a computer system 500 suitable for implementing one or more embodiments of the systems and methods disclosed herein, such as the client nodes 180 and 190, or the controller 105.

The computer system 500 includes a processor 502 that is in communication with memory devices including secondary storage 504, read only memory (ROM) 506, random access memory (RAM) 508, input/output (I/O) devices 510, and transmitter/receiver 512. Although illustrated as a single processor, the processor 502 is not so limited and may comprise multiple processors. The processor 502 may be implemented as one or more central processor unit (CPU) chips, cores (e.g., a multi-core processor), field-programmable gate arrays (FPGAs), ASICs, and/or digital signal processors (DSPs). The processor 502 may be configured to implement any of the schemes described herein, including the protocol 300. The processor 502 may be implemented using hardware or a combination of hardware and software.

The secondary storage 504 is typically comprised of one or more disk drives or tape drives and is used for non-volatile storage of data and as an over-flow data storage device if the RAM 508 is not large enough to hold all working data. The secondary storage 504 may be used to store programs that are loaded into the RAM 508 when such programs are selected for execution. The ROM 506 is used to store instructions and perhaps data that are read during program execution. The ROM 506 is a non-volatile memory device that typically has a small memory capacity relative to the larger memory capacity of the secondary storage 504. The RAM 508 is used to store volatile data and perhaps to store instructions. Access to both the ROM 506 and the RAM 508 is typically faster than to the secondary storage 504.

The transmitter/receiver 512 (sometimes referred to as a transceiver) may serve as an output and/or input device of the computer system 500. For example, if the transmitter/receiver 512 is acting as a transmitter, it may transmit data out of the computer system 500. If the transmitter/receiver 512 is acting as a receiver, it may receive data into the computer system 500. Further, the transmitter/receiver 512 may include one or more optical transmitters, one or more optical receivers, one or more electrical transmitters, and/or one or more electrical receivers. The transmitter/receiver 512 may take the form of modems, modem banks, Ethernet cards, universal serial bus (USB) interface cards, serial interfaces, token ring cards, fiber distributed data interface (FDDI) cards, and/or other well-known network devices. The transmitter/receiver 512 may enable the processor 502 to communicate with an Internet or one or more intranets. The I/O devices 510 may be optional or may be detachable from the rest of the computer system 500. The I/O devices 510 may include a video monitor, liquid crystal display (LCD), touch screen display, or other type of display. The I/O devices 510 may also include one or more keyboards, mice, or track balls, or other well-known input devices.

Similar to the network node 400, it is understood that by programming and/or loading executable instructions onto the computer system 500, at least one of the processor 502, the secondary storage 504, the RAM 508, and the ROM 506 are changed, transforming the computer system 500 in part into a particular machine or apparatus (e.g. a controller 105 or client devices 180 and 190). The executable instructions may be stored on the secondary storage 504, the ROM 506, and/or the RAM 508 and loaded into the processor 502 for execution.

Any processing of the present disclosure may be implemented by causing a processor (e.g., a general purpose CPU) to execute a computer program. In this case, a computer program product can be provided to a computer or a network device using any type of non-transitory computer readable media. The computer program product may be stored in a non-transitory computer readable medium in the computer or the network device. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), compact disc ROM (CD-ROM), compact disc recordable (CD-R), compact disc rewritable (CD-R/W), digital versatile disc (DVD), Blu-ray (registered trademark) disc (BD), and semiconductor memories (such as mask ROM, programmable ROM (PROM), erasable PROM, flash ROM, and RAM). The computer program product may also be provided to a computer or a network device using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line. The word “exemplary” is used herein to mean “serving as an example, instance, or illustration.” Any details described herein as “exemplary” is not necessarily to be construed as preferred or advantageous over other examples. Likewise, the term “examples” does not require that all examples include the discussed feature, advantage or mode of operation. Use of the terms “in one example,” “an example,” “in one feature,” and/or “a feature” in this specification does not necessarily refer to the same feature and/or example. Furthermore, a particular feature and/or structure can be combined with one or more other features and/or structures. Moreover, at least a portion of the apparatus described hereby can be configured to perform at least a portion of a method described hereby.

The terminology used herein is for the purpose of describing particular examples only and is not intended to be limiting of examples of the disclosure. As used herein, the singular forms “a,” “an,” and “the” are intended to include the plural forms as well, unless the context clearly indicates otherwise. It will be further understood that the terms “comprises”, “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should be noted that the terms “connected,” “coupled,” or any variant thereof, mean any connection or coupling, either direct or indirect, between elements, and can encompass a presence of an intermediate element between two elements that are “connected” or “coupled” together via the intermediate element.

Any reference herein to an element using a designation such as “first,” “second,” and so forth does not limit the quantity and/or order of those elements. Rather, these designations are used as a convenient method of distinguishing between two or more elements and/or instances of an element. Thus, a reference to first and second elements does not mean that only two elements can be employed, or that the first element must necessarily precede the second element. Also, unless stated otherwise, a set of elements can comprise one or more elements.

Further, many examples are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the examples described herein, the corresponding form of any such examples may be described herein as, for example, “logic configured to” perform the described action.

Nothing stated or illustrated depicted in this application is intended to dedicate any component, step, feature, benefit, advantage, or equivalent to the public, regardless of whether the component, step, feature, benefit, advantage, or the equivalent is recited in the claims.

Further, those of skill in the art will appreciate that the various illustrative logical blocks, modules, circuits, and algorithm steps described in connection with the examples disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The methods, sequences and/or algorithms described in connection with the examples disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

Although some aspects have been described in connection with a device, it goes without saying that these aspects also constitute a description of the corresponding method, and so a block or a component of a device should also be understood as a corresponding method step or as a feature of a method step. Analogously thereto, aspects described in connection with or as a method step also constitute a description of a corresponding block or detail or feature of a corresponding device. Some or all of the method steps can be performed by a hardware apparatus (or using a hardware apparatus), such as, for example, a microprocessor, a programmable computer or an electronic circuit. In some examples, some or a plurality of the most important method steps can be performed by such an apparatus.

In the detailed description above it can be seen that different features are grouped together in examples. This manner of disclosure should not be understood as an intention that the claimed examples require more features than are explicitly mentioned in the respective claim. Rather, the situation is such that inventive content may reside in fewer than all features of an individual example disclosed. Therefore, the following claims should hereby be deemed to be incorporated in the description, wherein each claim by itself can stand as a separate example. Although each claim by itself can stand as a separate example, it should be noted that-although a dependent claim can refer in the claims to a specific combination with one or a plurality of claims-other examples can also encompass or include a combination of said dependent claim with the subject matter of any other dependent claim or a combination of any feature with other dependent and independent claims. Such combinations are proposed herein, unless it is explicitly expressed that a specific combination is not intended. Furthermore, it is also intended that features of a claim can be included in any other independent claim, even if said claim is not directly dependent on the independent claim.

It should furthermore be noted that methods disclosed in the description or in the claims can be implemented by a device comprising means for performing the respective steps or actions of this method.

Furthermore, in some examples, an individual step/action can be subdivided into a plurality of sub-steps or contain a plurality of sub-steps. Such sub-steps can be contained in the disclosure of the individual step and be part of the disclosure of the individual step.

While the foregoing disclosure shows illustrative examples of the disclosure, it should be noted that various changes and modifications could be made herein without departing from the scope of the disclosure as defined by the appended claims. The functions, steps and/or actions of the method claims in accordance with the examples of the disclosure described herein need not be performed in any particular order. Additionally, well-known elements will not be described in detail or may be omitted so as to not obscure the relevant details of the aspects and examples disclosed herein. Furthermore, although elements of the disclosure may be described or claimed in the singular, the plural is contemplated unless limitation to the singular is explicitly stated.

What is claimed is:

1. A method for verifying a data path from a first client device through a software defined network to a second client device, the method comprising:
receiving a data path verification request from a first core node for the data path between the first client device and the second client device;
sending, by the first core node, a notification of the data path verification request to a controller;
sending, by the controller, a first data path verification packet to the first core node;
receiving, by the first core node, the first data path verification packet; and
sending, by the first core node, a second data path verification packet to a second core node, the second data path verification packet having information about the first data path verification packet.

2. The method of claim 1, further comprising:
receiving, by the second core node, the second data path verification packet;
sending, by the second core node, a third data path verification packet to the controller;
verifying, by the controller, that the third data path verification packet conforms to the data flow path information; and
sending, by the controller, a fourth data path verification packet to the second core node.

3. The method of claim 2, further comprising:
receiving, by the second core node, the fourth data path verification packet; and
sending, by the second core node, a fifth data path verification packet to the first core node, the fifth data path verification packet having information about the fourth data path verification packet.

4. The method of claim 3, further comprising:
receiving, by the first core node, the fifth data path verification packet;
sending, by the first core node, a sixth data path verification packet to the controller;
verifying, by the controller, that the sixth data path verification packet conforms to the data flow path information.

5. The method of claim 2, further comprising:
receiving, by the second core node, the fourth data path verification packet; and
sending, by the second core node, a fifth data path verification packet to a third core node, the fifth data path verification packet having information about the fourth data path verification packet.

6. The method of claim 5, further comprising:
receiving, by the third core node, the fifth data path verification packet;
sending, by the third core node, a sixth data path verification to the controller; and
verifying, by the controller, that the sixth data path verification packet conforms to the data flow path information.

7. The method of claim 6, further comprising:
determining, by the controller, that the sixth data path verification packet does not conform to the data flow path information; and
sending, by the controller, a seventh data path verification packet to the third core node in response to the sixth data flow packet not conforming to the data flow path information.

8. The method of claim 6, wherein the first data path verification packet, the second data path verification packet, the third data path verification packet, the fourth data path verification packet, the fifth data path verification packet, the sixth data path verification packet, and the seventh data path verification packet include additional information related to at least one of interfaces and nodes traveled, other overhead related fields about a health of a traveled node, interfaces, or links, or a service ID of a service for which the data path is being verified.

9. A network element comprising:
at least one transceiver configured to:
send a notification of the data path verification request to a controller for a data flow path between a first client device and a second client device;
receive a first data path verification packet from the controller; and
send a second data path verification packet to the controller, the second data path verification packet having information about the first data path verification packet.

10. The network element of claim 9, the at least one transceiver further configured to:
receive a third data path verification packet from the controller, the third data path verification packet having information about the second data path verification packet; and
send a fourth data path verification packet to the controller.

11. The network element of claim 9, the at least one transceiver further configured to:
receive a data packet from the first client device; and
send the data packet to a second network element based on the received data flow path information.

12. The network element of claim 10, the at least one transceiver further configured to:
receive second data flow path information from the controller in response to the fourth data path verification packet not conforming to the data flow path information;
receive a fifth data path verification packet from the controller; and
send the fifth data path verification packet to the controller.

13. The network element of claim 12, the at least one transceiver further configured to:
receive a data packet from the first client device; and
send the data packet to a second network element based on the received second data flow path information.

14. A controller comprising:
at least one transceiver configured to:
receive a notification of a data path verification request from a first core node for a data flow path between a first client device and a second client device;
send a first data path verification packet to the first core node; and
receive a second data path verification packet from the first core node that includes information about the first data path verification packet.

15. The controller of claim 14, the at least one transceiver further configured to:
verify that the second data path verification packet conforms to the data flow path information; and
send the second data path verification packet to the second core node.

16. The controller of claim 15, the at least one transceiver further configured to:
receive a third data path verification packet with information about the second data path verification packet from the second core node;
verify that the third data path verification packet conforms to the data flow path information; and
send the third data path verification packet to the first core node.

17. The controller of claim 16, the at least one transceiver further configured to:
receive a fourth data path verification packet from the first core node with information about the third data path verification packet; and
verify that the fourth data path verification packet conforms to the data flow path information.

18. The controller of claim 17, the at least one transceiver further configured to:
determine that the fourth data path verification packet does not conform to the data flow path information; and
determine a second data flow path in response to the fourth data path verification packet not conforming to the data flow path information.

19. The controller of claim 18, the at least one transceiver further configured to:
send second data flow path information to the first core node and the second core node; and
send a fifth data path verification packet to the first core node.

20. The controller of claim 19, wherein the first data path verification packet, the second data path verification packet, the third data path verification packet, the fourth data path verification packet, and the fifth data path verification packet include additional information related to at least one of interfaces and nodes traveled, other overhead related fields about a health of a traveled node, interfaces, or links, or a service ID of a service for which the data path is being verified.
